(19) United States
(12) Patent Application Publication
(10) Pub. No.: US 2025/0363167 A1
(43) Pub. Date: Nov. 27, 2025

(54) IMAGE PROCESSING METHOD AND APPARATUS, DEVICE, AND MEDIUM

(71) Applicant: TENCENT TECHNOLOGY (SHENZHEN) COMPANY LIMITED, Shenzhen (CN)

(72) Inventor: Cheng ZHU, Shenzhen (CN)

(21) Appl. No.: 19/298,022

(22) Filed: Aug. 12, 2025

Related U.S. Application Data
(63) Continuation of application No. PCT/CN2023/138315, filed on Dec. 13, 2023.

(30) Foreign Application Priority Data
Jun. 30, 2023 (CN) 202310795316.3

(51) Int. Cl. G06F 16/583; G06F 16/532; G06V 10/74; G06V 20/70

(52) U.S. Cl. CPC G06F 16/583; G06F 16/532; G06V 10/761; G06V 20/70

(57) ABSTRACT

In an image processing method, a reference library and a query library are obtained; a reference image in the reference library and a prompt are inputted into a diffusion model to obtain estimated noise; the estimated noise is merged to obtain a reference noise feature; a plurality of query noise features corresponding to a query image are determined; and a target label corresponding to the query image is determined based on feature similarities between the plurality of query noise features and the reference noise features.

### CROSS-REFERENCES TO RELATED APPLICATIONS

This application is a continuation of PCT Application No. PCT/CN2023/138315, filed on Dec. 13, 2023, which claims priority to Chinese Patent Application No. 202310795316.3, filed with the China National Intellectual Property Administration on Jun. 30, 2023 and entitled “IMAGE PROCESSING METHOD AND APPARATUS, DEVICE, MEDIUM, AND PROGRAM PRODUCT”, the entire contents of all of which are incorporated herein by reference.

### FIELD OF THE TECHNOLOGY

The present disclosure relates to the field of computer technologies, and in particular, to image processing.

### BACKGROUND OF THE DISCLOSURE

With the rapid development of artificial intelligence technologies, deep learning models are widely applied to tasks such as image classification and detection. As training data is continuously updated, how to adapt newly updated training data to be added to a deep learning model becomes a difficult problem.

Generally, both existing training data and to-be-added training data may be inputted into the deep learning model for training, to complete adaptation of the to-be-added training data.

However, because the to-be-added training data is a sporadic sample, it is difficult to quickly complete model adaptation through data accumulation, and a training process takes long time, affecting image processing efficiency in a training data configuration process.

### SUMMARY

The present disclosure provides an image processing method, which can effectively improve image processing efficiency in a training data configuration process.

According to a first aspect of the present disclosure, an image processing method is provided, which may be applied to a system or program including an image processing function in a terminal device, and includes: obtaining a reference library and a query library, the reference library comprising reference images configured with corresponding image labels; inputting the reference images in the reference library and prompts corresponding to the reference images into a diffusion model, to obtain estimated noise corresponding to the reference images, each prompt being determined based on a corresponding image label; merging, based on the image labels corresponding to the reference images, the estimated noise corresponding to the reference images, to obtain reference noise features corresponding to the image labels; combining a query image in the query library and the image labels separately to obtain a plurality of query combinations, to input the plurality of query combinations into the diffusion model to obtain a plurality of query noise features corresponding to the query image; and determining a target label corresponding to the query image based on feature similarities between the plurality of query noise features and the reference noise features.

According to a second aspect of the present disclosure, an image processing apparatus is provided, including: an obtaining unit, configured to obtain a reference library and a query library, the reference library comprising reference images configured with corresponding image labels; an estimation unit, configured to input the reference images in the reference library and prompts corresponding to the reference images into a diffusion model, to obtain estimated noise corresponding to the reference images, each prompt being determined based on a corresponding image label; and a processing unit, configured to merge, based on the image labels corresponding to the reference images, the estimated noise corresponding to the reference images, to obtain reference noise features corresponding to the image labels, where the processing unit, further configured to combine a query image in the query library and the image labels separately to obtain a plurality of query combinations, to input the plurality of query combinations into the diffusion model to obtain a plurality of query noise features corresponding to the query image; and the processing unit, further configured to determine a target label corresponding to the query image based on feature similarities between the plurality of query noise features and the reference noise features.

According to a third aspect of the present disclosure, a computer device is provided, including: a memory, a processor, and a bus system, the memory being configured to store program code; and the processor being configured to perform, based on instructions in the program code, the image processing method according to the foregoing first aspect or any implementation of the first aspect.

According to still another aspect of the embodiments of the present disclosure, a non-transitory storage medium is provided, the storage medium being configured to store a computer program, and the computer program being configured to perform the method according to the foregoing aspects.

A reference library and a query library are obtained, the reference library comprising reference images configured with corresponding image labels; the reference image in the reference library and a prompt corresponding to the reference image are inputted into a diffusion model, to obtain estimated noise corresponding to reference images, each prompt being determined based on a corresponding image label; the estimated noise corresponding to the reference images is merged based on the image labels corresponding to the reference images, to obtain reference noise features corresponding to the image labels; a query image in the query library and the image labels are combined separately to obtain a plurality of query combinations, to input the plurality of query combinations into the diffusion model to obtain a plurality of query noise features corresponding to the query image; and a target label corresponding to the query image is determined based on feature similarities between the plurality of query noise features and the reference noise features, thereby implementing a label configuration process without training. Because a noise difference, obtained through the diffusion model, between images in the reference library and the query library is used to indicate an image similarity matching process, a corresponding label can be configured for the query library without training, thereby improving image processing efficiency in a training data configuration process.

### BRIEF DESCRIPTION OF THE DRAWINGS

FIG. 1 is a network architecture diagram of running an image processing system.

FIG. 2 is an architecture diagram of an image processing procedure according to an embodiment of the present disclosure.

FIG. 3 is a flowchart of an image processing method according to an embodiment of the present disclosure.

FIG. 4 is a schematic scenario diagram of an image processing method according to an embodiment of the present disclosure.

FIG. 5 is a schematic scenario diagram of another image processing method according to an embodiment of the present disclosure.

FIG. 6 is a schematic scenario diagram of another image processing method according to an embodiment of the present disclosure.

FIG. 7 is a schematic scenario diagram of another image processing method according to an embodiment of the present disclosure.

FIG. 8 is a schematic scenario diagram of another image processing method according to an embodiment of the present disclosure.

FIG. 9 is a schematic scenario diagram of another image processing method according to an embodiment of the present disclosure.

FIG. 10 is a flowchart of another image processing method according to an embodiment of the present disclosure.

FIG. 11 is a schematic structural diagram of an image processing apparatus according to an embodiment of the present disclosure.

FIG. 12 is a schematic structural diagram of a terminal device according to an embodiment of the present disclosure.

FIG. 13 is a schematic structural diagram of a server according to an embodiment of the present disclosure.

### DESCRIPTION OF EMBODIMENTS

Embodiments of the present disclosure provide an image processing method and related apparatus. The method and related apparatus may be applied to a system or program including an image processing function in a terminal device, and can configure a corresponding label for the query library without training, thereby improving image processing efficiency in a training data configuration process.

In the specification, claims, and accompanying drawings of the present disclosure, the terms “first”, “second”, “third”, “fourth”, and the like (if any) are configured for distinguishing similar objects and not necessarily configured for describing any particular order or sequence. Data used in this way is interchangeable where appropriate, so that embodiments of the present disclosure described here, for example, can be implemented in an order other than those illustrated or described here. In addition, the terms “comprise”, “corresponding to”, and any other variants are intended to cover the non-exclusive inclusion. For example, a process, method, system, product, or device that includes a series of operations or units is not necessarily limited to those expressly listed operations or units, but may include other operations or units not expressly listed or inherent to the process, method, product, or device.

First, some terms that may appear in the embodiments of the present disclosure are explained as follows.

Stable diffusion model (stable diffusion, sd model): It is a latent space diffusion model with conditions.

Chatgpt: It is a large language model that may be for common generation of information such as sentences and dialogs.

Prompt: It is content that indicates a prompt text in the sd model, and is basically a short sentence.

Text-to-image: It means that an input is a prompt, and an output is a generated image.

Image-to-text: It means that an input is an image, and an output is a description of the image, that is, a prompt.

Reference library (gallery library): It is a base library configured to search for related images during a search query. An image in the reference library carries a label, that is, during a query, an image having a most similar feature in the gallery library can be found and a label corresponding to the image is returned.

Query library: it contains images used for search queries.

Training-free: It indicates that a result is directly obtained without separate training.

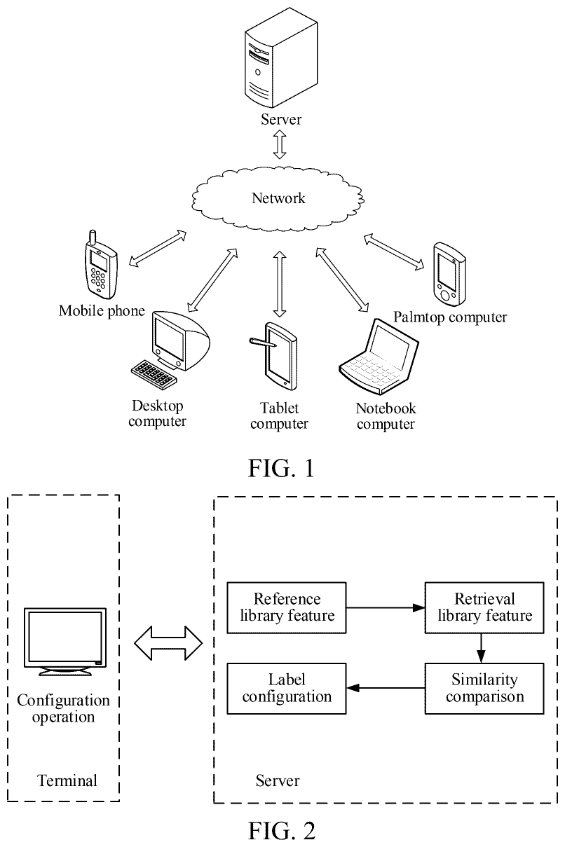

The image processing method provided in the present disclosure may be applied to a system or program including an image processing function in a terminal device, for example, a content generation application. Specifically, an image processing system may be run on a network architecture shown in FIG. 1. FIG. 1 is a network architecture diagram of running an image processing system. As can be learned from the figure, the image processing system may provide an image processing process for a plurality of information sources, that is, a data configuration operation of a terminal is performed to trigger a server to perform label configuration operation on to-be-added data, and add the to-be-added data to an existing reference library, to support running of a diffusion model. FIG. 1 shows a plurality of terminal devices, and the terminal device may be a computer device. In an actual scenario, more or fewer types of terminal devices may participate in the image processing process. A specific quantity and type of terminal devices are determined based on the actual scenario, and are not limited herein. In addition, FIG. 1 shows one server, but in the actual scenario, there may be a plurality of servers, and a specific quantity of servers is determined based on the actual scenario.

In this embodiment, the server may be an independent physical server, or a server cluster or a distributed system composed of a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The terminal may be but is not limited to a smartphone, a tablet computer, a notebook computer, a desktop computer, a smart speaker, a smartwatch, a smart voice interaction device, a smart appliance, or a vehicle-mounted terminal. The terminal and the server may be directly or indirectly connected through wired or wireless communication, and the terminal and the server may be connected to form a blockchain network. This is not limited in the present disclosure.

The foregoing image processing system may be run in a personal mobile terminal, for example, a content generation application. The image processing system may also be run in a server, or may be run in a third-party device to provide image processing, to obtain an image processing result of an information source. A specific image processing system may be run in the foregoing devices in a form of a program, or may be run in the foregoing devices as a system component, or may be used as one of cloud service programs. This embodiment may be applied to scenarios such as a cloud technology and automated driving. A specific running mode is determined based on an actual scenario, and is not limited herein.

With the rapid development of artificial intelligence technologies, deep learning models are widely applied to tasks such as image classification and detection. As training data is continuously updated, how to adapt to-be-added training data to a deep learning model becomes a difficult problem.

Generally, both existing training data and to-be-added training data may be inputted into the deep learning model for training, to complete adaptation of the to-be-added training data.

However, because the to-be-added training data is a sporadic sample, it is difficult to quickly complete model adaptation through data accumulation, and a training process takes long time, affecting image processing efficiency in a training data configuration process.

To resolve the foregoing problem, the present disclosure provides an image processing method. The method is applied to an image processing procedure framework shown in FIG. 2. FIG. 2 is an architecture diagram of an image processing procedure according to an embodiment of the present disclosure. A difference between predicted noise with guidance by a text condition and predicted noise without guidance by a text condition in a diffusion model is converted into a difference between noise of a reference library and noise of a query library, and then a similarity difference between the noise of the reference library and the noise of the query library is calculated. In addition, in this solution, training does not need to be performed again, thereby efficiently performing label configuration on newly to-be-added data.

The method provided in the present disclosure may be writing of a program, and used as processing logic in a hardware system, or may be used as an image processing apparatus, where the processing logic is implemented in an integrated or external manner. In an implementation, the image processing apparatus obtains a reference library and a query library, the reference library comprising reference images configured with corresponding image labels; inputs the reference images in the reference library and prompts corresponding to the reference images into a diffusion model, to obtain estimated noise corresponding to the reference images, each prompt being determined based on a corresponding image label; merges, based on the image labels corresponding to the reference images, the estimated noise corresponding to the reference images, to obtain reference noise features corresponding to the image labels; combines a query image in the query library and the image labels separately to obtain a plurality of query combinations, to input the plurality of query combinations into the diffusion model to obtain a plurality of query noise features corresponding to the query image; and determines a target label corresponding to the query image based on feature similarities between the plurality of query noise features and the reference noise features, thereby implementing a label configuration process without training. Because a noise difference, obtained through the diffusion model, between images in the reference library and the query library is used to indicate an image similarity matching process, a corresponding label can be configured for the query library without training. This improves image processing efficiency in a training data configuration process.

The embodiments provided in the embodiments of the present disclosure relate to computer vision technologies of artificial intelligence, and are specifically described by using the following embodiments.

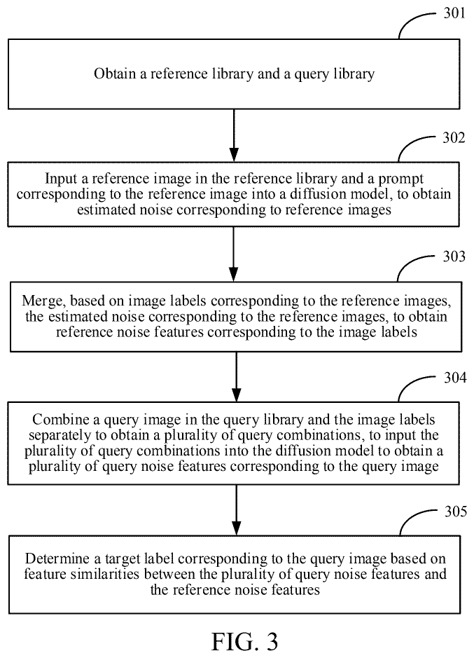

With reference to the foregoing procedure architecture, the following describes an image processing method in the present disclosure. Referring to FIG. 3, FIG. 3 is a flowchart of an image processing method according to an embodiment of the present disclosure. The processing method may be performed by a server or a terminal. The embodiment of the present disclosure includes at least the following operations:

301: Obtain a reference library and a query library.

In this embodiment, the reference library is a base library configured to search for related images in a query task. By executing the query task, a reference image having a most similar feature in the reference library is found during retrieval, and an image label corresponding to the reference image is returned as a target label of a query image. Therefore, image labels are configured for reference images in the reference library. The query library is an image set configured for retrieving a label. The set may include training data indicating that a deep learning model needs to be trained (where a corresponding target label needs to be added). The query library may be related to different scenarios, that is, an objective of adding a scenario to a deep learning model that has been used is achieved, so that the deep learning model adapts to a scenario corresponding to the query library.

In some embodiments, considering that there is a large amount of data in a training set in which the reference images in the reference library are located, when the reference library is added, reference images having a category the same as or similar to that of the query library may be selected from the training set to generate a reference library that is needed for this query task. To be specific, a query library associated with the query task is obtained; category information corresponding to the query library is determined; and image invoking is performed, based on the category information, on reference images in the training set that are associated with the query task, to obtain the reference library.

In one embodiment, the query task may be executed based on a diffusion model (used as an example of the foregoing deep learning model). In other words, the reference library is training data of the diffusion model. This type of model attenuates information caused by noise, and then uses learned information to generate an image. An sd model is used as an example for description in this embodiment. The sd model is trained through LAION-5B, and a model of LAION-5B is trained with billions of data. The present disclosure can make full use of a capability of training an sd model on a large-scale data set. This embodiment points out that a process of image-image matching is equivalent to a process of matching an average feature of noise in a gallery library with an average feature of a query library, and then a method for measuring an image-image similarity is designed, so that a matching result can be obtained without additional model training.

Reference images having category information corresponding to the query library are determined from the training set to form the reference library, so that not only the amount of data of the reference library is effectively controlled, but also the reference library is more relevant to the query task, thereby effectively improving matching efficiency and matching quality for a target label of the query library.

Through label configuration for the query library, the diffusion model may be migrated to more common work such as classification, detection, and matching in an actual field. In this embodiment, an sd model is used as an example to describe a process in which migration is applied to the embodiment for matching. The migration process is adapted to various data, and a label is quickly configured through comparison of similarities of noise features, to complete rapid deployment of data.

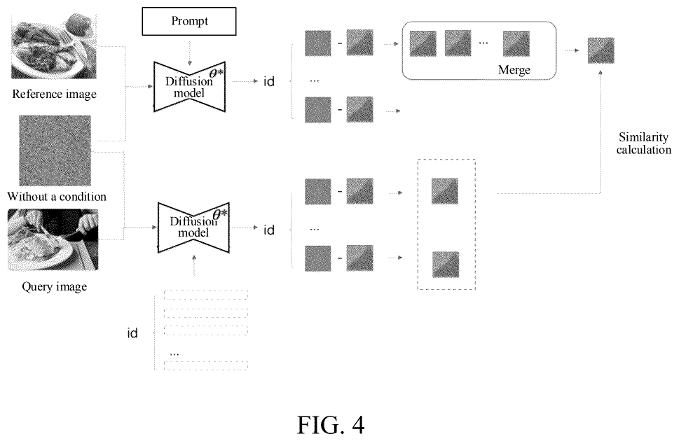

Specifically, a process of comparing the reference library with the query library in this embodiment is shown in FIG. 4. FIG. 4 is a schematic scenario diagram of an image processing method according to an embodiment of the present disclosure. As shown in the figure, a difference between predicted noise with guidance by a text condition and predicted noise without guidance by a text condition in an sd model is converted into a difference between noise of a gallery library and noise of a query library, and then a similarity difference between the noise of the gallery library and the noise of the query library is calculated. In addition, in this embodiment, training does not need to be performed again.

An objective of this embodiment is to directly add a small amount of data and corresponding target labels, to the gallery library, so that during online use, for the query library used as online data, only whether the query library matches a reference image in the gallery library needs to be determined, and if the query library matches the reference image in the gallery library, a target label corresponding to the reference image is returned.

302: Input the reference images in the reference library and prompts corresponding to the reference images into a diffusion model, to obtain estimated noise corresponding to the reference images.

In this embodiment, the prompt is determined based on the image label. For example, if the image label is a knife, the prompt is knife. The diffusion model is a pre-training model, and may be obtained by training based on the reference image. In other words, the reference image is training data of the sd model.

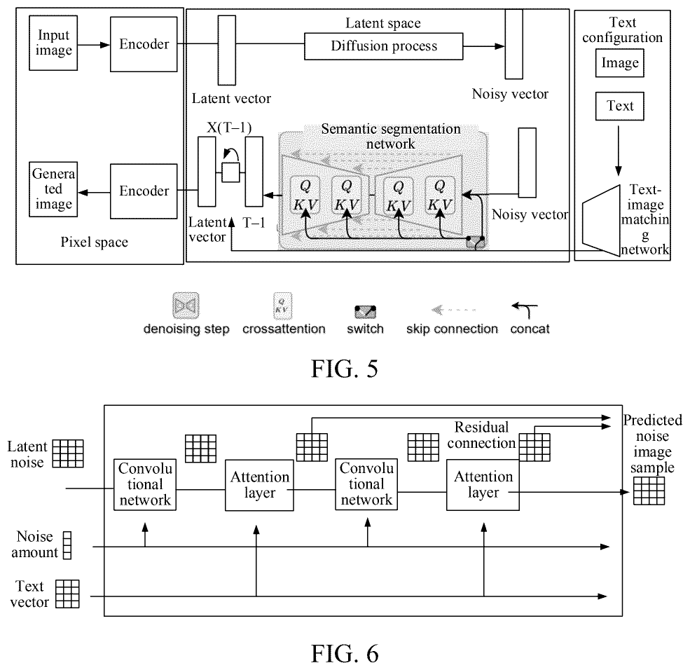

Specifically, a process of determining the estimated noise corresponding to the reference image may be a processing process based on the sd model. A structure of the sd model is shown in FIG. 5. FIG. 5 is a schematic scenario diagram of another image processing method according to an embodiment of the present disclosure. As shown in the figure, the sd model includes an encoder, a decoder, a text-image matching network, and a semantic segmentation network. Specifically, the reference image in the reference library is inputted into the encoder in the diffusion model, to obtain a latent vector corresponding to the reference image. A diffusion process is executed, that is, noise is added to the latent vector, to obtain a noisy vector. The prompt corresponding to the reference image is inputted into a text-image matching network (CLIP model) in the diffusion model, to obtain a text vector. A denoising process is executed, that is, the noisy vector is inputted into the semantic segmentation network (u-net model) in the diffusion model. Further, the estimated noise corresponding to the reference image is predicted by using the text vector and the noisy vector through the semantic segmentation network in the diffusion model.

In the related art, both noise-adding and denoising are performed for a plurality of times through the diffusion model, to generate images, where specific information is removed in each denoising process. However, in this embodiment, the semantic segmentation network in the diffusion model is used to perform one-time prediction on the estimated noise by using the text vector and the noisy vector, and the denoising process may not be involved. The estimated noise obtained through one-time prediction includes a lot of information, so that a reference noise feature includes a lot of information. Similarly, the query noise features include a lot of information, thereby improving accuracy of determining the target label by using the similarities between the reference noise features and the query noise features.

A process of determining the estimated noise is shown in FIG. 6. FIG. 6 is a schematic scenario diagram of another image processing method according to an embodiment of the present disclosure. First, in the foregoing diffusion process in the sd model, different noise amounts are controlled at different t moments, and the different t moments correspond to different noise estimation stages, so that noisy images at the different noise estimation stages are obtained. The model calculates a difference between a noise amount and endowed noise through a u-net model with conditions. Therefore, this embodiment may also be combined with the process of performing noise-adding and denoising for a plurality of times.

Specifically, a combination of prompts in the process in which processing is performed for a plurality of times, that is, a section of description text (prompt), may be first decompressed to an embedding vector through a text encoder in the CLIP. In a denoising process of the u-net, an attention mechanism may be continuously used to inject an embedding vector to the denoising process. Each Resnet is no longer directly connected to an adjacent Resnet, but an attention module is newly added between the Resnet and the adjacent Resnet. After semantic embedding is obtained by the CLIP, the semantic embedding is inputted into the attention module again for processing. In this way, semantic information may be continuously injected, to combine the text vector and the noisy vector.

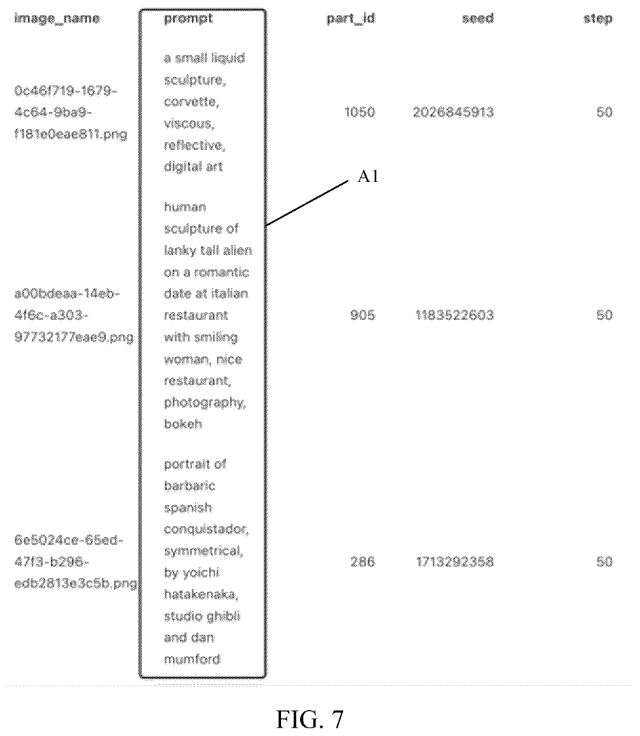

In one embodiment, a data set format used by the sd model for training may be parsed, to extract an accurate prompt. The data set format used by the sd model for training is shown in FIG. 7. FIG. 7 is a schematic scenario diagram of another image processing method according to an embodiment of the present disclosure. Box selected content Al in the figure is a prompt configured for the sd model, and a format of the prompt may be a photo of {class}.

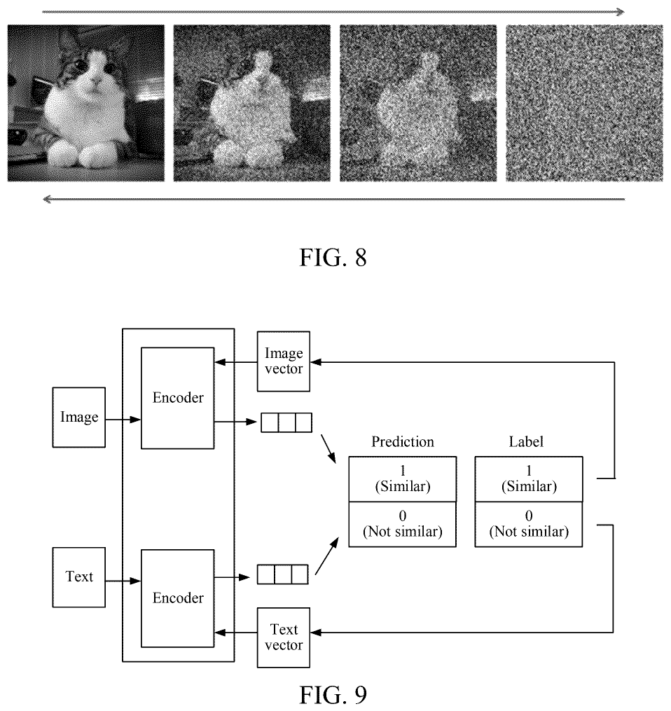

In addition, considering that the denoising process is performed step by step, as shown in FIG. 8, FIG. 8 is a schematic scenario diagram of another image processing method according to an embodiment of the present disclosure. Each noise estimation stage (timestep) is gradually performed as time passes by. Therefore, in addition to selecting an output of a last noise estimation stage as estimated noise, an output of any one of the noise estimation stages may also be selected as estimated noise to perform noise representation on the reference library. Therefore, a target stage may be determined from the noise estimation stage, and the target stage in the noise estimation stage is determined based on scenario information.

A target stage is selected for the noise estimation stage in a targeted manner, so that calculation burden can be effectively reduced, and efficiency of determining estimated noise can be improved.

In one embodiment, scenario information corresponding to a query task related to the reference library and the query library is obtained, and a target stage is determined based on the scenario information. Different scenario information marks target stages of different query tasks (for example, scenarios corresponding to the query library). The estimated noise corresponding to the reference image in the target stage is predicted by using the text vector and the noisy vector through the semantic segmentation network in the diffusion model, to be adapted to noise sensitivity in different scenarios.

In addition, target stages (timesteps for extracting the estimated noise) in different scenarios may be determined by performing performance statistics after an experiment. To be specific, test noise of the reference image in each noise estimation stage is predicted by using the text vector and the noisy vector through the semantic segmentation network in the diffusion model; a query task is executed based on the test noise (that is, the query task is executed after marking of a target label is performed in a subsequent embodiment), to obtain effect information (such as an accuracy rate and a conversion rate) corresponding to each noise estimation stage; and a target stage is determined based on a performance parameter indicated in the effect information, to improve adaptability in different scenarios.

To accelerate an image generation process, the sd model does not choose to run a diffusion process on a pixel image, but chooses to run the diffusion process on a compressed version of the image. Therefore, size adaption needs to be performed on an inputted reference image. To be specific, size information adapted to latent space corresponding to the diffusion model is obtained; the reference image in the reference library is adjusted based on the size information; and an adjusted reference image is inputted into the encoder in the diffusion model, to obtain a latent vector corresponding to the reference image, so as to match the diffusion process of the diffusion model. The latent space may be model space configured for expressing and generating a latent vector.

With reference to the descriptions of the foregoing embodiment, for determining the estimated noise, a size of the reference images in the gallery library may be first uniformly adjusted to 512*512 through the existing sd model, where a prompt used in the sd model is an original image label (for example, if the image label is a knife, the prompt is knife); and estimated noise is obtained after each category is inputted into the sd model (for example, a last timestep of the sd model is used), and obtained estimated noise is also 512*512.

In an architecture shown in FIG. 5, a used text image matching model (contrastive language-image pre-training, CLIP) may perform quick matching between a text and an image. This is because the CLIP model includes an image encoder and a text encoder. A training process thereof is first randomly extracting an image and a text from a training set. The text and the image may not match each other. A task of the CLIP model is to predict whether an image and a text match each other, so as to perform training.

Specifically, a training process of the CLIP model is shown in FIG. 9. FIG. 9 is a schematic scenario diagram of another image processing method according to an embodiment of the present disclosure. As shown in the figure, after a text and an image are randomly extracted, the text and the image may be respectively compressed by the image encoder and the text encoder into two embedding vectors, which are referred to as image embedding and text embedding, that is, two 3*1 vectors in the figure. Then, a similarity between the two embedding vectors may be compared in terms of a cosine similarity, to determine whether the randomly extracted text and image match each other.

In an initial training stage, even though an image and a text are well matched, parameters are chaotic because the two possible encoders are just initialized. Therefore, the two embedding vectors are definitely chaotic, and a calculated similarity is usually close to 0. Therefore, a situation may occur. An image and a text are matched as a pair, and an image label marks the image and the text as being similar, but a prediction result obtained through cosine similarity calculation is not similar. In this case, the image label (similar) does not match the prediction result (not similar), and back propagation may be performed based on the matching result, to update the parameters of the two encoders. By continuously repeating this back propagation process, training of the two encoders can be completed. For the image and the text that match each other, the two encoders may finally output similar embedding vectors, and a result obtained through cosine similarity calculation may be close to 1. However, for an image and a text that does not match, the two encoders output greatly different embedding vectors, so that the cosine similarity obtained through calculation is close to 0.

In one embodiment, an image of a puppy is inputted into the CLIP model, and a text is described as “puppy image”. The CLIP model generates two similar embedding vectors, to determine that the text matches the image. An image and a text form a unified mathematical for representation. Therefore, the text may be converted into image information through a text encoder, or the text may be converted into language information through an image encoder. The two can be mutually converted, to be configured in the sd model, so as to improve a matching degree between the text and the image.

According to the foregoing descriptions of the sd model, calculation of a predicted value of a label is to calculate a difference between estimated noise with guidance by different text (label) conditions and estimated noise without guidance by a condition. A smaller difference indicates that the predicted value belongs to a corresponding text or label. Therefore, it may be set that estimated noise obtained by using an image (under any label) in the gallery library is A, estimated noise obtained by using an image (under any label) in the query library is B, and estimated noise obtained by using an image (under no label) without guidance by a condition is C, so that a similarity between any two images in the gallery library and the query library is:

$$\vert A - C \vert - \vert B - C \vert = \vert A - B \vert$$

Therefore, calculating the similarity may be to directly calculate a difference between estimated noise of an image in the gallery library and estimated noise of an image in the query library. A process of calculating the difference between estimated noise is described as follows.

303: Merge, based on the image labels corresponding to the reference images, the estimated noise corresponding to the reference images, to obtain reference noise features corresponding to the image labels.

In this embodiment, the process of merging the estimated noise based on the image labels is a process of merging estimated noise of image categories indicated by the image labels. Because a same image label corresponds to multiple noise estimation of different images, noise may be merged. In other words, assuming that the training set has N labels, and each label has {n1, n2, . . . nn} images, noise features obtained for each category under the N labels need to be combined. Assuming that the image label corresponds to n1 mages, n1 pieces of 512*512 estimated noise are obtained.

Specifically, these estimated noise is summed pixel by pixel to obtain an average value, to finally obtain estimated noise of a first category, and estimated noise of N categories is obtained by using the same method. For this process, first the estimated noise corresponding to the reference images under an image label is obtained, to obtain a noise set; summation is performed on the estimated noise in the noise set, to obtain a total noise amount; and an average value of the total noise amount is obtained based on an amount of the estimated noise in the noise set, to obtain the reference noise features corresponding to the image label.

In addition, because images with a same label are similar, an estimated noise feature may be determined based on a median. In other words, in a merging process, statistics collection may further be performed on values of the estimated noise in the noise set at a plurality of pixels (e.g., all pixels of the image), to obtain a statistical result; and a median of the values at the pixels in the statistical result is determined, to obtain the reference noise features corresponding to the image label.

Because the average value or the median of the reference image under the image label can reflect distribution of the estimated noise from an overall level, reference noise features determined by using the average value or the median of the estimated noise can more comprehensively reflect noise features of the reference images under the image labels.

The foregoing merging method is merely an example, and a specific manner of merging is determined based on an actual scenario.

304: Combine a query image in the query library and the image labels separately to obtain a plurality of query combinations, to input the plurality of query combinations into the diffusion model to obtain a plurality of query noise features corresponding to the query image.

In this embodiment, the plurality of query combinations are inputted into the diffusion model, that is, to obtain features of the query library. An obtaining process thereof is similar to that in the gallery library. To be specific, images in the query library are first resized to 512*521, and then are inputted into a frozen sd model in sequence. However, an inputted prompt is a label system set of the current reference library. The following query combination input can be obtained:

$$image + label 1 ;$$

$$image + label 2 ;$$

$$…$$

$$image + label n .$$

Therefore, n 512*512 feature sets can be obtained.

The foregoing embodiment describes a process of determining the estimated noise based on different noise estimation stages. In this case, target stages (timesteps) used in a process of determining the query noise feature need to correspond to each other. To be specific, the target stage in the noise estimation stage used when the estimated noise corresponds to the reference image is obtained; the query image and the image labels in the query library are combined separately to obtain a plurality of query combinations; and the plurality of query combinations are inputted into the diffusion model, to obtain, based on the target stage, the plurality of query noise features corresponding to the query image, thereby improving effectiveness of a feature comparison process.

305: Determine a target label corresponding to the query image based on feature similarities between the plurality of query noise features and the reference noise features.

In this embodiment, a feature similarity comparison process may be performed through a comparison unit, for example, an individual pixel or a pixel unit of another size. A feature similarity calculation process may be performed by calculating a cosine similarity.

In one embodiment, the cosine similarities of n 512*512-dimensional features obtained for each image in the query library and N estimated noise in the gallery library may be separately calculated pixel by pixel as follows:

$$cos ( θ ) = \frac{{\sum }_{k = 1}^{n} {x}_{1 k} {x}_{2 k}}{\sqrt{{\sum }_{k = 1}^{n} {x}_{1 k}^{2}} \sqrt{{\sum }_{k = 1}^{n} {x}_{2 k}^{2}}}$$

x1 represents a comparison unit in the reference noise feature, x2 represents a comparison unit in the query noise feature, and k represents a quantity of pixels, that is, a quantity of 512*512 points. An image category corresponding to a query image is obtained by using a reference label in a gallery library that corresponds to a minimum value of the cosine similarity, and a corresponding target label is determined.

In addition, to improve comparison efficiency, similarity calculation may further be performed based on a comparison window, and the comparison window can accurately identify a feature sampling range for feature comparison. In other words, a plurality of adjacent pixels are used as comparison units for similarity calculation. Specifically, a comparison window configured for a query task is obtained; sampling is performed on the query noise features based on the comparison window, to obtain query window features; sampling is performed on the reference noise features based on the comparison window, to obtain reference window features; cosine similarity calculation is performed on the query window features and the reference window features, to obtain the feature similarities; and a target label corresponding to the query image is determined based on the feature similarities, thereby implementing an efficient comparison process.

In addition, because the query library in this embodiment is configured for added training data, and a deployment period of a corresponding product needs to be considered, comparison window configuration may be performed based on different efficiency requirements. To be specific, time limit information configured for the query task is obtained; quantity information corresponding to query images in the query library is determined; an efficiency parameter is determined based on the time limit information and the quantity information; the efficiency parameter is compared with preset efficiency, to obtain an acceleration ratio (for example, if the efficiency parameter is four times the preset efficiency, the acceleration ratio is 4); and the comparison window is configuring based on the acceleration ratio, for example, a 2*2 pixel window is configured to perform similarity comparison, to adapt to a model deployment requirement.

According to the foregoing label annotation process, similar images in the gallery library can be quickly matched based on a small amount of data, and labels of the similar images are returned. The process can be efficiently completed because training is not needed.

According to the foregoing embodiment, a reference library and a query library are obtained, the reference library comprising reference images configured with corresponding image labels; the reference image in the reference library and a prompt corresponding to the reference image are inputted into a diffusion model, to obtain estimated noise corresponding to reference images, each prompt being determined based on a corresponding image label; the estimated noise corresponding to the reference images is merged based on the image labels corresponding to the reference images, to obtain reference noise features corresponding to the image labels; a query image in the query library and the image labels are combined separately to obtain a plurality of query combinations, to input the plurality of query combinations into the diffusion model to obtain a plurality of query noise features corresponding to the query image; and a target label corresponding to the query image is determined based on feature similarities between the plurality of query noise features and the reference noise features, thereby implementing a label configuration process without training. Because a noise difference, obtained through the diffusion model, between images in the reference library and the query library is used to indicate an image similarity matching process, a corresponding label can be configured for the query library without training, thereby improving image processing efficiency in a training data configuration process.

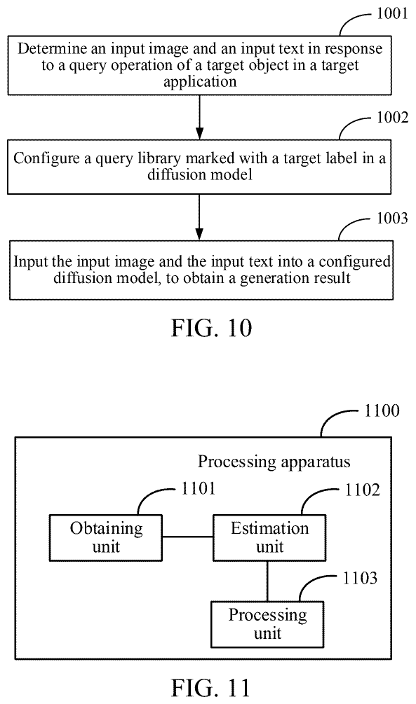

The foregoing embodiment describes a process of configuring a label for the query library. After the label is configured, the label may be quickly added to the reference library, so as to execute a related task based on the diffusion model. This scenario is described as follows. Referring to FIG. 10, FIG. 10 is a flowchart of another image processing method according to an embodiment of the present disclosure. An embodiment of the present disclosure includes at least the following operations.

1001: Determine an input image and an input text in response to query operation of a target object in a target application.

In this embodiment, the target application is associated with a query library, that is, a capability of a diffusion model corresponding to a reference library is migrated to a field corresponding to the target application, for example, tasks such as classification, detection, and matching. A specific task form is determined based on an actual scenario.

1002: Configure the query library marked with the target label in the diffusion model.

In this embodiment, the query library marked with the target label is configured in the diffusion model, thereby implementing migration of the capacity of the diffusion model. In other words, a small amount of data from a client and a configured target label are directly added to the reference library. Therefore, during online use, only whether the online data used as the query library matches an image in the reference library needs to be determined, and if the online data matches the image in the reference library, a label corresponding to the online data is returned.

Specifically, for a process of configuring the target label, refer to operations 301 to 305 in the embodiment shown in FIG. 3, and details are not described herein again.

1003: Input the input image and the input text into a configured diffusion model, to obtain a generation result.

In this embodiment, the diffusion model may be a large-scale image generation model in a cv field represented by sd. In addition, the diffusion model may alternatively be a large-scale text question answering model in an nlp field represented by a gpt series.

By migrating a generation capacity of the diffusion model obtained through a training set with a hundred million data to an application corresponding to the query library, a development period of the application can be shortened, and performance of the application can be rapidly improved. For example, if the target application is image generation in artificial intelligence generated content, a new style needs to be added to an existing image style (reference library), and then the query library may be configured based on the new style. After the foregoing label annotation is performed, the query library may be quickly adapted to an existing generation model without training, thereby implementing an efficient image processing process.

To better implement the foregoing embodiment of the embodiments of the present disclosure, a related apparatus for implementing the foregoing embodiment is further provided as follows. Referring to FIG. 11, FIG. 11 is a schematic structural diagram of an image processing apparatus according to an embodiment of the present disclosure. A processing apparatus 1100 includes:

an obtaining unit 1101, configured to obtain a reference library and a query library, the reference library comprising reference images configured with corresponding image labels;

an estimation unit 1102, configured to input the reference images in the reference library and prompts corresponding to the reference images into a diffusion model, to obtain estimated noise corresponding to the reference images, each prompt being determined based on a corresponding image label; and

a processing unit 1103, configured to merge, based on the image labels corresponding to the reference images, the estimated noise corresponding to the reference images, to obtain reference noise features corresponding to the image labels, where

the processing unit 1103, further configured to combine a query image in the query library and the image labels separately to obtain a plurality of query combinations, to input the plurality of query combinations into the diffusion model to obtain a plurality of query noise features corresponding to the query image; and

the processing unit 1103, further configured to determine a target label corresponding to the query image based on feature similarities between the plurality of query noise features and the reference noise features.

In some embodiments, the estimation unit 1102 is specifically configured to input the reference image in the reference library into an encoder in the diffusion model, to obtain a latent vector corresponding to the reference image;

the estimation unit 1102 is specifically configured to add noise to the latent vector, to obtain a noisy vector;

the estimation unit 1102 is specifically configured to input the prompt corresponding to the reference image into a text-image matching network in the diffusion model, to obtain a text vector; and

the estimation unit 1102 is specifically configured to predict the estimated noise corresponding to the reference images by using the text vector and the noisy vector through a semantic segmentation network in the diffusion model.

In some embodiments, the estimation unit 1102 is specifically configured to determine a target stage in the noise estimation stage; and

the estimation unit 1102 is specifically configured to predict the estimated noise corresponding to the reference images in the target stage by using the text vector and the noisy vector through a semantic segmentation network in the diffusion model.

In some embodiments, the estimation unit 1102 is specifically configured to obtain scenario information corresponding to a query task related to the reference library and the query library; and determine the target stage in the noise estimation stage based on the scenario information.

Alternatively, the estimation unit 1102 is specifically configured to predict the test noise corresponding to the reference images in noise estimation stages by using the text vector and the noisy vector through a semantic segmentation network in the diffusion model;

the estimation unit 1102 is specifically configured to execute the query task based on the test noise, to obtain effect information corresponding to the noise estimation stages; and

the estimation unit 1102 is specifically configured to determine the target stage based on the performance parameters indicated in the effect information.

In some embodiments, the estimation unit 1102 is specifically configured to obtain a target stage in the noise estimation stage used when the corresponding estimated noise is determined based on the reference image; and

the estimation unit 1102 is specifically configured to execute, based on the target stage, a process of determining a query noise feature in the diffusion model by using the plurality of query combinations.

In some embodiments, the estimation unit 1102 is specifically configured to obtain size information that is adapted to latent space corresponding to the diffusion model;

the estimation unit 1102 is specifically configured to adjust the reference image in the reference library based on the size information; and

the estimation unit 1102 is specifically configured to input an adjusted reference image into the encoder in the diffusion model, to obtain the latent vector corresponding to the reference image.

In some embodiments, the obtaining unit 1101 is specifically configured to obtain the query library associated with the query task;

the obtaining unit 1101 is specifically configured to determine category information corresponding to the query library; and

the obtaining unit 1101 is specifically configured to perform image invoking on a training set associated with the query task based on the category information, to obtain the reference library.

In some embodiments, the obtaining unit 1101 is specifically configured to obtain estimated noise corresponding to each reference image under the image label, to obtain a noise set

the obtaining unit 1101 is specifically configured to perform summation on the estimated noise in the noise set, to obtain a total noise amount; and

the obtaining unit 1101 is specifically configured to obtain an average value of the total noise amount based on an amount of the estimated noise in the noise set, to obtain the reference noise feature corresponding to the image label.

In some embodiments, the processing unit 1103 is specifically configured to obtain estimated noise corresponding to each reference image under the image label, to obtain a noise set;

the processing unit 1103 is specifically configured to perform value statistics on values of the estimated noise in the noise set at all pixel, to obtain a statistical result; and

the processing unit 1103 is specifically configured to determine a median of the values at all the pixels in the statistical result, to obtain the reference noise feature corresponding to the image label.

In some embodiments, the processing unit 1103 is specifically configured to obtain a comparison window configured for a query task, the query task being associated with the query library;

the processing unit 1103 is specifically configured to perform sampling on the query noise features based on the comparison window, to obtain query window features;

the processing unit 1103 is specifically configured to perform sampling on the reference noise features based on the comparison window, to obtain reference window features;

the processing unit 1103 is specifically configured to perform cosine similarity calculation on the query window features and the reference window features, to obtain the feature similarities; and

the processing unit 1103 is specifically configured to determine the target label corresponding to the query image based on the feature similarities.

In some embodiments, the processing unit 1103 is specifically configured to obtain time limit information configured for the query task;

the processing unit 1103 is specifically configured to determine quantity information corresponding to query images in the query library;

the processing unit 1103 is specifically configured to determine an efficiency parameter based on the time limit information and the quantity information;

the processing unit 1103 is specifically configured to compare the efficiency parameter with preset efficiency, to obtain an acceleration ratio; and

the processing unit 1103 is specifically configured to configure the comparison window based on the acceleration ratio.

In some embodiments, the processing unit 1103 is specifically configured to determine an input image and an input text in response to query operation of the target object in a target application, the target application being associated with the query library;

the processing unit 1103 is specifically configured to configure the query library marked with the target label in the diffusion model;

the processing unit 1103 is specifically configured to input the input image and the input text into a configured diffusion model, to obtain a generation result.

A reference library and a query library are obtained, the reference library comprising reference images configured with corresponding image labels; the reference image in the reference library and a prompt corresponding to the reference image are inputted into a diffusion model, to obtain estimated noise corresponding to reference images, each prompt being determined based on a corresponding image label; the estimated noise corresponding to the reference images is merged based on the image labels corresponding to the reference images, to obtain reference noise features corresponding to the image labels; a query image in the query library and the image labels are combined separately to obtain a plurality of query combinations, to input the plurality of query combinations into the diffusion model to obtain a plurality of query noise features corresponding to the query image; and a target label corresponding to the query image is determined based on feature similarities between the plurality of query noise features and the reference noise features, thereby implementing a label configuration process without training. Because a noise difference, obtained through the diffusion model, between images in the reference library and the query library is used to indicate an image similarity matching process, a corresponding label can be configured for the query library without training, thereby improving image processing efficiency in a training data configuration process.

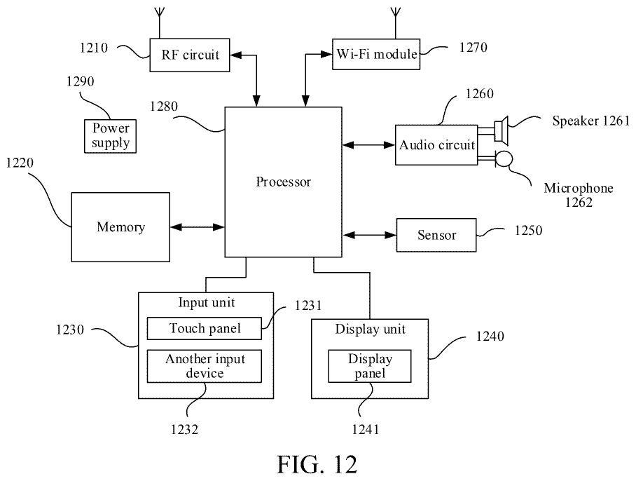

The embodiments of the present disclosure further provide a terminal device. FIG. 12 is a schematic structural diagram of another terminal device according to an embodiment of the present disclosure. For ease of description, only parts related to the embodiments of the present disclosure are shown. For specific technical details that are not disclosed, refer to the method part in the embodiments of the present disclosure. The terminal device may be any terminal device such as a mobile phone, a tablet computer, a personal digital assistant (PDA), a point of sales (POS), or a vehicle-mounted computer. An example in which the terminal is a mobile phone is used.

FIG. 12 is a block diagram of a structure of a part of a mobile phone related to a terminal according to an embodiment of the present disclosure. Referring to FIG. 12, the mobile phone includes: components such as a radio frequency (RF) circuit 1210, a memory 1220, an input unit 1230, a display unit 1240, a sensor 1250, an audio circuit 1260, a wireless fidelity (Wi-Fi) module 1270, a processor 1280, and a power supply 1290. A person skilled in the art may understand that the structure of the mobile phone shown in FIG. 12 does not constitute a limitation on the mobile phone. The mobile phone may include more or fewer components than those shown in the figure, or may combine some components, or may have different component arrangements.

The following specifically describes the components of the mobile phone with reference to FIG. 12.

The RF circuit 1210 may be configured to receive and transmit signals during an information receiving and sending process or a call process.

The memory 1220 may be configured to store a software program and a module. The processor 1280 runs the software program and the module that are stored in the memory 1220, to perform various functional applications and data processing of the mobile phone.

The input unit 1230 may be configured to receive input digit or character information, and generate a keyboard signal input related to a user setting and function control of the mobile phone. Specifically, the input unit 1230 may include a touch panel 1231 and another input device 1232.

The display unit 1240 may be configured to display information inputted by the user or information provided for the user, and various menus of the mobile phone. The display unit 1240 may include a display panel 1241.

The mobile phone may further include at least one sensor 1250.

The audio circuit 1260, a speaker 1261, and a microphone 1262 may provide audio interfaces between the user and the mobile phone.

The processor 1280 is a control center of the mobile phone, and is connected to various parts of the entire mobile phone by using various interfaces and lines. By running or executing the software program and/or the module stored in the memory 1220, and invoking data stored in the memory 1220, the processor executes various functions of the mobile phone and performs data processing, thereby monitoring the entire mobile phone.

The mobile phone further includes the power supply 1290 (such as a battery) for supplying power to the components. In some embodiments, the power supply may be logically connected to the processor 1280 through a power management system, thereby implementing functions such as charging, discharging, and power consumption management through the power management system.

Although not shown in the figure, the mobile phone may further include a camera, a Bluetooth module, and the like, which are not described in detail herein.

In the embodiments of the present disclosure, the processor 1280 included in the terminal further has a function of performing the operations of the foregoing page processing method.

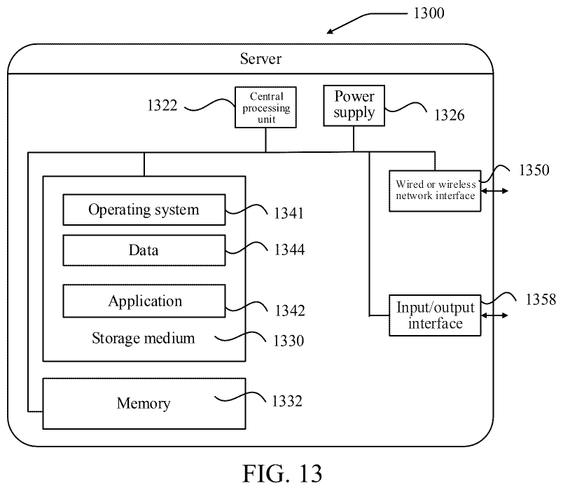

The embodiments of the present disclosure further provide a server. Referring to FIG. 13, FIG. 13 is a schematic structural diagram of a server according to an embodiment of the present disclosure. A server 1300 may vary greatly due to different configurations or performance, and may include one or more central processing units (CPU) 1322 (for example, one or more processors) and a memory 1332, and one or more storage medium 1330 (for example, one or more mass storage devices) that store an application 1342 or data 1344. The memory 1332 and the storage medium 1330 may be temporarily stored or permanently stored. The program stored in the storage medium 1330 may include one or more modules (not shown in the figure), and each module may include a series of instructions and operation for the server. Still further, the central processing unit 1322 may be configured to communicate with the storage medium 1330, and perform, on the server 1300, a series of instructions and operation in the storage medium 1330.

The server 1300 may further include one or more power supplies 1326, one or more wired or wireless network interfaces 1350, one or more input/output interfaces 1358, and/or one or more operating systems 1341, for example, Windows Server™, Mac OS X™, Unix™, Linux™, or FreeBSD™.

Operations performed by the management apparatus in the foregoing embodiments may be based on the server structure shown in FIG. 13.

In addition, the embodiments of the present disclosure further provide a storage medium. The storage medium is configured to store a computer program. The computer program is configured to perform the method provided in the foregoing embodiments.

The embodiments of the present disclosure further provide a computer program product including a computer program. When the computer program product is run on a computer, the computer is enabled to perform the method provided in the foregoing embodiments.

The embodiments of the present disclosure further provide an image processing system. The image processing system may include the image processing apparatus in the embodiment described in FIG. 11, the terminal device in the embodiment described in FIG. 12, or the server described in FIG. 13.

A person skilled in the art can clearly understand that for convenience and conciseness of description, for specific working processes of the foregoing systems, apparatuses and units, refer to the corresponding processes in the foregoing method embodiments, and details are not described herein again.

In the embodiments provided in the present disclosure, the disclosed system, apparatus, and method may be implemented in other manners. For example, the apparatus embodiment described above is merely an example. For example, division into the units is merely logical function division, and may be another division during actual implementation. For example, a plurality of units or components may be combined or integrated into another system, or some features may be ignored or not executed. In addition, the shown or discussed mutual couplings or direct couplings or communication connections may be implemented through some interfaces. The indirect couplings or communication connections between the apparatus or units may be implemented in electronic, mechanical, or other forms.

The units described as separate parts may or may not be physically separate, and parts displayed as units may or may not be physical units. To be specific, the parts may be located in one place or may be distributed on a plurality of network units. Some or all of the units may be selected based on an actual requirement to implement the objectives of the embodiments of the present disclosure.

In addition, functional units in embodiments of the present disclosure may be integrated into one processing unit, or each of the units may exist alone physically, or two or more units are integrated into one unit. The integrated unit may be implemented in a form of hardware or a software functional unit.

If the integrated unit is implemented in the form of the software functional unit and is sold or used as an independent product, the integrated unit may be stored in a computer-readable storage medium. Based on such an understanding, the technical embodiments of the present disclosure essentially, or the part contributing to the related art, or all or a part of the technical embodiments may be implemented in a form of a software product. The computer software product is stored in a storage medium, and includes several instructions for instructing a computer device (which may be a personal computer, an image processing apparatus, a network device, or the like) to perform all or some of the operations of the methods described in the embodiments of the present disclosure. However, the foregoing storage medium includes: any medium that can store program code, such as a USB flash drive, a removable hard disk, a read-only memory (ROM), a random access memory (RAM), a magnetic disk, or an optical disc.

Based on the above, the foregoing embodiments are merely intended to describe the technical embodiments of the present disclosure, and are not intended to limit the present disclosure. Although the present application is described in detail with reference to the foregoing embodiments, it is appreciated by a person skilled in the art that, modifications may still be made to the technical solutions described in the foregoing embodiments, or equivalent replacements may be made to the part of the technical features; as long as such modifications or replacements do not cause the essence of corresponding technical embodiments to depart from the spirit and scope of the technical embodiments of the embodiments of the present application.

What is claimed is:

1. An image processing method, performed by a computer device, the method comprising:
obtaining a reference library and a query library, the reference library comprising reference images configured with corresponding image labels;
inputting the reference images in the reference library and prompts corresponding to the reference images into a diffusion model, to obtain estimated noise corresponding to the reference images, each prompt being determined based on a corresponding image label;
merging, based on the image labels corresponding to the reference images, the estimated noise corresponding to the reference images, to obtain reference noise features corresponding to the image labels;
combining a query image in the query library and the image labels separately to obtain a plurality of query combinations, inputting the plurality of query combinations into the diffusion model to obtain a plurality of query noise features corresponding to the query image; and
determining a target label corresponding to the query image based on feature similarities between the plurality of query noise features and the reference noise features.

2. The method according to claim 1, wherein the inputting the reference images in the reference library and prompts corresponding to the reference images into a diffusion model, to obtain estimated noise corresponding to the reference images comprises: for a reference image,
inputting the reference image in the reference library into an encoder in the diffusion model, to obtain a latent vector corresponding to the reference image;
adding noise to the latent vector, to obtain a noisy vector;
inputting the prompt corresponding to the reference image into a text-image matching network in the diffusion model, to obtain a text vector; and
predicting the estimated noise corresponding to the reference image by using the text vector and the noisy vector through a semantic segmentation network in the diffusion model.

3. The method according to claim 2, wherein the predicting the estimated noise corresponding to the reference image by using the text vector and the noisy vector through a semantic segmentation network in the diffusion model comprises:
determining a target stage in a noise estimation stage; and
predicting the estimated noise corresponding to the reference image in the target stage by using the text vector and the noisy vector through the semantic segmentation network in the diffusion model.

4. The method according to claim 3, wherein the determining a target stage in a noise estimation stage comprises:
obtaining scenario information corresponding to a query task related to the reference library and the query library; and
determining the target stage in the noise estimation stage based on the scenario information.

5. The method according to claim 3, wherein the determining a target stage in a noise estimation stage comprises:
predicting test noise corresponding to the reference image in noise estimation stages by using the text vector and the noisy vector through the semantic segmentation network in the diffusion model;
executing the query task based on the test noise, to obtain effect information corresponding to the noise estimation stages; and
determining the target stage based on a performance parameter indicated in the effect information.

6. The method according to claim 3, wherein the method further comprises:
obtaining the target stage in the noise estimation stage used when the corresponding estimated noise is determined based on the reference image; and
executing, based on the target stage, a process of determining a query noise feature in the diffusion model by using the plurality of query combinations.

7. The method according to claim 2, wherein the inputting the reference image in the reference library into an encoder in the diffusion model, to obtain a latent vector corresponding to the reference image comprises:
obtaining size information adapted to latent space corresponding to the diffusion model;
adjusting the reference image in the reference library based on the size information; and
inputting an adjusted reference image into the encoder in the diffusion model, to obtain the latent vector corresponding to the reference image.

8. The method according to claim 1, wherein the obtaining a reference library and a query library comprises:
obtaining the query library associated with a query task;
determining category information corresponding to the query library; and
performing image invoking on a training set associated with the query task based on the category information, to obtain the reference library.

9. The method according to claim 1, wherein the merging, based on the image labels corresponding to the reference images, the estimated noise corresponding to the reference images, to obtain reference noise features corresponding to the image labels comprises: for an image label,
obtaining the estimated noise corresponding to the reference images under the image label, to obtain a noise set;
performing summation on the estimated noise in the noise set, to obtain a total noise amount; and
obtaining an average value of the total noise amount based on an amount of the estimated noise in the noise set, to obtain the reference noise feature corresponding to the image label.

10. The method according to claim 1, wherein the merging, based on the image labels corresponding to the reference images, the estimated noise corresponding to the reference images, to obtain reference noise features corresponding to the image labels comprises: for an image label,
obtaining the estimated noise corresponding to the reference images under the image label, to obtain a noise set;
performing value statistics on values of the estimated noise in the noise set at a plurality of pixels, to obtain a statistical result; and
determining a median of the values at the plurality of pixels in the statistical result, to obtain the reference noise feature corresponding to the image label.

11. The method according to claim 1, wherein the determining a target label corresponding to the query image based on feature similarities between the plurality of query noise features and the reference noise features comprises:
obtaining a comparison window configured for a query task, the query task being associated with the query library;
performing sampling on the query noise features based on the comparison window, to obtain query window features;
performing sampling on the reference noise features based on the comparison window, to obtain reference window features;
performing cosine similarity calculation on the query window features and the reference window features, to obtain the feature similarities; and
determining the target label corresponding to the query image based on the feature similarities.

12. The method according to claim 11, wherein the obtaining a comparison window configured for a query task comprises:
obtaining time limit information configured for the query task;
determining quantity information corresponding to query images in the query library;
determining an efficiency parameter based on the time limit information and the quantity information;
comparing the efficiency parameter with preset efficiency, to obtain an acceleration ratio; and
configuring the comparison window based on the acceleration ratio.

13. The method according to claim 1, wherein the method further comprises:
determining an input image and an input text in response to a query operation of a target object in a target application, the target application being associated with the query library;
configuring the query library marked with the target label in the diffusion model; and
inputting the input image and the input text into a configured diffusion model, to obtain a generation result.

14. A computer device, comprising a processor and a memory,
the memory being configured to store program code; and the processor being configured to, based on instructions in the program code, perform:
obtaining a reference library and a query library, the reference library comprising reference images configured with corresponding image labels;
inputting the reference images in the reference library and prompts corresponding to the reference images into a diffusion model, to obtain estimated noise corresponding to the reference images, each prompt being determined based on a corresponding image label;
merging, based on the image labels corresponding to the reference images, the estimated noise corresponding to the reference images, to obtain reference noise features corresponding to the image labels;
combining a query image in the query library and the image labels separately to obtain a plurality of query combinations, inputting the plurality of query combinations into the diffusion model to obtain a plurality of query noise features corresponding to the query image; and
determining a target label corresponding to the query image based on feature similarities between the plurality of query noise features and the reference noise features.

15. The computer device according to claim 14, wherein the inputting the reference images in the reference library and prompts corresponding to the reference images into a diffusion model, to obtain estimated noise corresponding to the reference images comprises: for a reference image,
inputting the reference image in the reference library into an encoder in the diffusion model, to obtain a latent vector corresponding to the reference image;
adding noise to the latent vector, to obtain a noisy vector;
inputting the prompt corresponding to the reference image into a text-image matching network in the diffusion model, to obtain a text vector; and
predicting the estimated noise corresponding to the reference image by using the text vector and the noisy vector through a semantic segmentation network in the diffusion model.

16. The computer device according to claim 15, wherein the predicting the estimated noise corresponding to the reference image by using the text vector and the noisy vector through a semantic segmentation network in the diffusion model comprises:
determining a target stage in a noise estimation stage; and
predicting the estimated noise corresponding to the reference image in the target stage by using the text vector and the noisy vector through the semantic segmentation network in the diffusion model.

17. The computer device according to claim 16, wherein the determining a target stage in a noise estimation stage comprises:
obtaining scenario information corresponding to a query task related to the reference library and the query library; and
determining the target stage in the noise estimation stage based on the scenario information.

18. The computer device according to claim 16, wherein the determining a target stage in a noise estimation stage comprises:
predicting test noise corresponding to the reference image in noise estimation stages by using the text vector and the noisy vector through the semantic segmentation network in the diffusion model;
executing the query task based on the test noise, to obtain effect information corresponding to the noise estimation stages; and
determining the target stage based on a performance parameter indicated in the effect information.

19. The computer device according to claim 16, wherein the processor is further configured to perform:
obtaining the target stage in the noise estimation stage used when the corresponding estimated noise is determined based on the reference image; and
executing, based on the target stage, a process of determining a query noise feature in the diffusion model by using the plurality of query combinations.

20. A non-transitory storage medium, the storage medium being configured to store a computer program, and the computer program, when being executed by at least one processor, causing the at least one processor to perform:
obtaining a reference library and a query library, the reference library comprising reference images configured with corresponding image labels;
inputting the reference images in the reference library and prompts corresponding to the reference images into a diffusion model, to obtain estimated noise corresponding to the reference images, each prompt being determined based on a corresponding image label;
merging, based on the image labels corresponding to the reference images, the estimated noise corresponding to the reference images, to obtain reference noise features corresponding to the image labels;
combining a query image in the query library and the image labels separately to obtain a plurality of query combinations, inputting the plurality of query combinations into the diffusion model to obtain a plurality of query noise features corresponding to the query image; and
determining a target label corresponding to the query image based on feature similarities between the plurality of query noise features and the reference noise features.
